(19) United States
(12) Patent Application Publication
(10) Pub. No.: US 2018/0327040 A1
(43) Pub. Date: Nov. 15, 2018

(54) Bicycle with Integral Electrical Generator

(71) Applicant: Timothy B. Spicer, Fort Worth, TX (US)

(72) Inventor: Timothy B. Spicer, Fort Worth, TX (US)

(21) Appl. No.: 15/817,769

(22) Filed: Nov. 20, 2017

Related U.S. Application Data
(60) Provisional application No. 62/424,671, filed on Nov. 21, 2016.

(51) Int. Cl. B62J 6/06; B62K 19/40; B62K 19/02; B62J 6/02; B62J 99/00; H02K 7/18

(52) U.S. Cl. CPC B62J 6/06; B62K 19/40; B62K 19/02; B62J 6/04; B62J 99/00; H02K 7/1846; B62J 2099/004; B62J 6/02

(57) ABSTRACT

A bicycle includes a frame formed of various interconnected tubes with a front wheel and a rear wheel mounted thereon. The frame includes a headlight module and taillight module that are each powered by an internal rechargeable battery. A pair of pedals at the lower end of the frame operate an internal generator to automatically recharge the battery whenever the rider is pedaling.

The present invention relates to a bicycle having an integral electrical generator for powering various lighting and any connected electronic accessories.

### DESCRIPTION OF THE PRIOR ART

Many bicycles are equipped with headlights, taillights and/or turn indicators for enhanced safety. Typically, the lights are powered by disposable batteries that inconveniently deplete without warning and often when the rider cannot immediately access replacement batteries. Furthermore, repeatedly replacing disposable batteries is costly, burdensome and inconvenient. Rechargeable batteries are an unacceptable alternative because they have limited capacity and must be continuously recharged.

Accordingly, there is currently a need for a method or more efficiently and reliably powering bicycle lighting. The present invention addresses this need by providing a bicycle having an integral electrical generator for powering various lighting and any connected electronic accessories.

### SUMMARY OF THE INVENTION

The present invention relates to a bicycle comprising a frame formed of various interconnected tubes with a front wheel and a rear wheel mounted thereon. The frame includes a headlight module and a taillight module that are each powered by an internal rechargeable battery. A pair of pedals at the lower end of the frame operate an internal generator to automatically recharge the battery whenever the rider is pedaling.

It is therefore an object of the present invention to provide a bicycle that automatically generates electricity as a rider is pedaling.

It is therefore another object of the present invention to provide a bicycle having an integral generator for powering numerous safety lights and any connected electronic components.

Other objects, features, and advantages of the present invention will become readily apparent from the following detailed description of the preferred embodiment when considered with the attached drawings and the appended claims.

### BRIEF DESCRIPTION OF THE DRAIWNGS

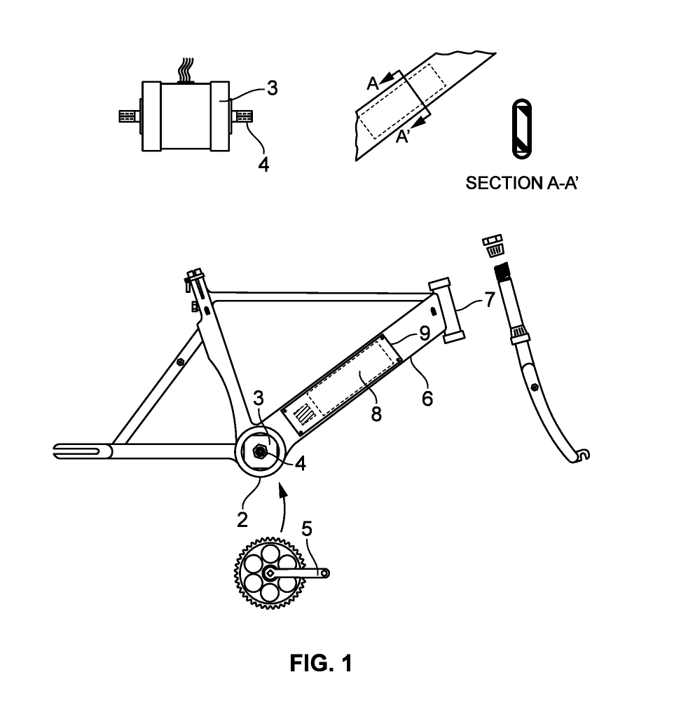

FIG. 1 is an isolated view of the bicycle frame according to the present invention.

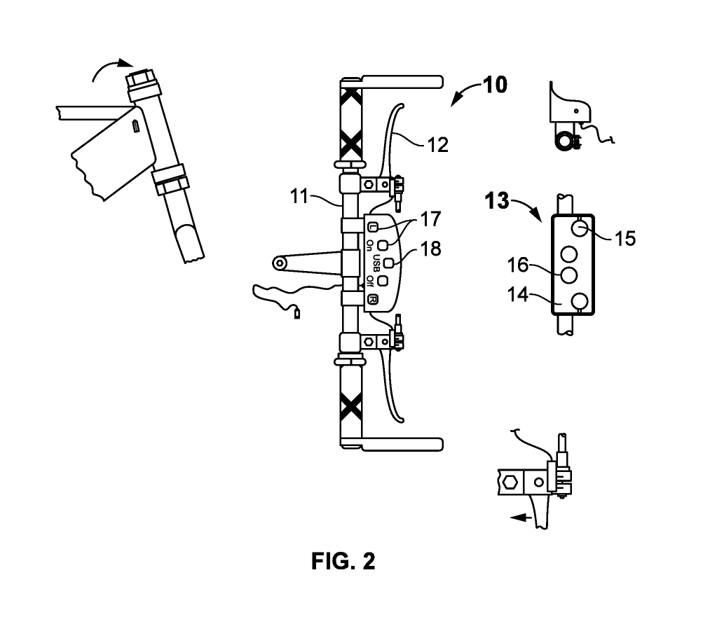

FIG. 2 is an isolated view of the handlebar assembly.

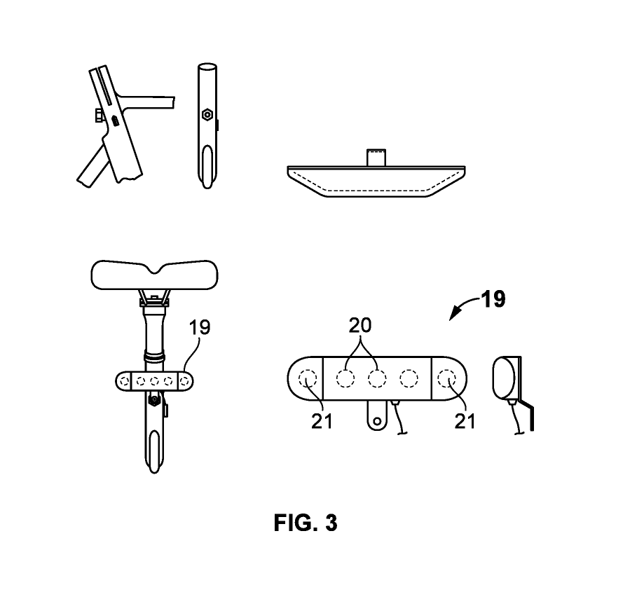

FIG. 3 is an isolated view of the taillight module.

### DESCRIPTION OF THE PREFERRED EMBODIMENT

The present invention relates to a bicycle comprising a frame 1 which provides support for the bicycle 100 and the user and which may be formed of various interconnected tubes which may be hollow or solid with a front wheel and a rear wheel mounted thereon. FIGS. 1, 2 and 3 illustrate the bicycle 100 of the present invention. At the lower end of a seat-supported tube is a hollow cylinder 2 with a two-phase stepping motor 3 received therein and, by the virtue of the motor 3 being positioned in the hollow cylinder 2 and directly connected to the pipe pedals 5 the motor is internal and integral to the bicycle 100. The motor 3 may be directly connected to the pedals 5 to generate electricity which may be used to power various lights and devices attached to the bicycle 100. Extending from each of two opposing sides of the motor is a rotor shaft 4 that is configured to couple with a designated bicycle pedal 5. When a rider is pedaling, the motor becomes a generator and transmits electricity to an outlet.

A down tube 6 extends from the lower end of the seat-support tube to a handlebar tube 7. Received within the down tube is a rechargeable battery 8 that is electrically connected to the generator outlet to receive electrical power to recharge the battery 8 and to supply electrical power to the lights and devices of the bicycle 100. A removable hatch 9 on the down tube 6 provides selective access to the battery for maintenance or nondestructive replacement. A seat may be mounted on the opposing end of the down tube 6 which may be held by a clamp. The taillight, brake light and turn signal lights may be mounted under the seat on a seat riser stem and may be protected by the seat and plugged into a polarized conductor connected to the battery 8. The frame 1 may be formed with an internal opening for the routing of power cables from the battery 8 to the required locations.

Removably attached to the handlebar tube 7 is a handlebar assembly 10 including a crossbar 11 having a pair of reciprocal brake levers 12 mounted thereon which may engage the brake lights 20. Mounted on a central portion of the crossbar is a headlight module 13 having a transparent lens 14 on a front side. Immediately behind the lens are “left” and “right” turn-indicator LEDs 15 with headlight LEDs 16 therebetween. On an upper surface of the light module 13 are switches 17 that activate the LEDs 15, 16 and one or more USB ports 18 for connecting accessory electronic devices, such as wireless phones. The USB ports 18 and LEDs 15, 16 are powered by the rechargeable battery 8, which is automatically replenished whenever the rider is pedaling by power from the motor 3.

Mounted on the rear surface of the seat-support tube is a taillight module 19 having central brake-light LEDs 20 and “left” and “right” turn-indicator LEDs 21. The brake-light LEDs 20 are activated when either of the brake levers are engaged, while the turn-signal LEDs 21 are activated by the switches on the headlight module 13. Therefore, the numerous safety lights and USB ports are powered by an internal battery that is automatically recharged whenever a rider is pedaling. A polarized mating connector 33 includes all the wires required to feed the operating signals to the microcontroller 31

The above-described device is not limited to the exact details of construction and enumeration of parts provided herein. Furthermore, the size, shape and materials of construction of the various components can be varied without departing from the spirit of the present invention.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

1) A bicycle for generating electric power, comprising;
a frame to support the bicycle;
a motor to generate the electric power being positioned integral to the frame.

2) A bicycle for generating electric power as in claim 1, wherein the bicycle includes a pedal directly connected to the motor.

3) A bicycle for generating electric power as in claim 1, wherein the frame includes a hollow cylinder to house the motor.

4) A bicycle for generating electric power as in claim 1, wherein the motor includes a pair of opposing rotor shaft to connect to a pair of pedals.

5) A bicycle for generating electric power as in claim 1, wherein the motor is connected to a down tube of the bicycle.

6) A bicycle for generating electric power as in claim 5, wherein a rechargeable battery is housed in the down tube of the bicycle. cm 7) A bicycle for generating electric power as in claim 6, wherein the down tube includes a removable hatch for the rechargeable battery.

8) A bicycle for generating electric power as in claim 5, wherein the down tube is connected to a handlebar assembly.

9) A bicycle for generating electric power as in claim 8, wherein the handlebar assembly includes a headlight module.

10) A bicycle for generating electric power as in claim 8, wherein the handlebar assembly includes a controller.

11) A bicycle for generating electric power as in claim 8, wherein the handlebar assembly is connected to a USB port.
